(19) United States
(12) Patent Application Publication
(10) Pub. No.: US 2015/0352764 A1
(43) Pub. Date: Dec. 10, 2015

(54) INJECTION DEVICE AND MOLDING APPARATUS

(71) Applicant: Toshiba Kikai Kabushiki Kaisha, Tokyo (JP)

(72) Inventors: Daisuke NAKAMURA, Kawasaki-shi (JP); Makoto FUNABA, Yamato-shi (JP); Toshiaki TOYOSHIMA, Zama-shi (JP); Yuji ABE, Fujisawa-shi (JP); Saburo NODA, Atsugi-shi (JP)

(21) Appl. No.: 14/732,348

(22) Filed: Jun. 5, 2015

(30) Foreign Application Priority Data
Jun. 5, 2014 (JP) 2014-116570

(51) Int. Cl. B29C 45/17

(52) U.S. Cl. CPC B29C 45/1775; B29L 2031/00

(57) ABSTRACT

An injection device has an injection cylinder device which is connected to a plunger and a driving device which is capable of driving a plunger to move forward through the injection cylinder device. A cylinder part of the injection cylinder device has a front cylinder member which accommodates an injection piston so that it can slide in a front-back direction, is opened at the rear end, and is movable in the front-back direction. Further, the cylinder part has a back cylinder member which communicates with the rear end of the front cylinder member and is provided in a fixed manner. The driving device can drive the front cylinder member in the front-back direction.

### TECHNICAL FIELD

The present invention relates to a molding apparatus (molding machine) and an injection device of the same. The molding apparatus is for example a die cast machine or an injection molding machine.

### BACKGROUND ART

Known in the art is a so-called hybrid type injection device which drives a plunger which extrudes a molding material in a sleeve into a cavity by a combination of a fluid pressure device and another drive device (for example an electric motor).

For example, the injection devices in Patent Literature 1 and Patent Literature 2 have an injection cylinder device which is connected to a plunger, a ball screw mechanism capable of making the injection cylinder device move, and an electric motor which drives the ball screw mechanism. This injection device drives the electric motor to perform low speed injection then supplies a working fluid to the injection cylinder device while continuing drive of the electric motor to perform high speed injection.

### CITATIONS LIST

### Patent Literature

Patent Literature 1: Japanese Patent Publication No. 2006-315050A
Patent Literature 2: Japanese Patent Publication No. 2008-114234A

### SUMMARY OF INVENTION

### Technical Problem

When supplying a high pressure working fluid to an injection cylinder device and making a piston move forward, according to the law of action and reaction, a backward force (reaction force) is applied to a cylinder member accommodating the piston. In the arts of Patent Literature 1 and Patent Literature 2, this reaction force must be received by the ball screw mechanism and electric motor. That is, the injection force must be received by the electric motor.

More specifically, the cylinder member which tries to move backward due to the reaction force tries to rotate the ball screw mechanism in a reverse direction to that at the time of forward movement. The electric motor must generate a driving force which counters the force trying to rotate the mechanism in reverse. As a result, for example, the load of the electric motor increases. Further, for example, when the cylinder member moves backward, acceleration at the time of high speed falls.

Accordingly, it is demanded to provide an injection device and molding apparatus capable of suitably receiving injection force.

### Solution to Problem

An injection device according to one aspect of the present invention has a sleeve which is communicated with a cavity; a plunger which is capable of sliding in a front-back direction in the sleeve; an injection cylinder device which includes a piston rod which is connected to the plunger, an injection piston which is fixed to the piston rod, and a cylinder part which accommodates the injection piston; and a driving device which is capable of driving the plunger to move forward through the injection cylinder device. The cylinder part has a front cylinder member which accommodates the injection piston so that it can slide in a front-back direction, is opened at the rear end, and is movable in a front-back direction; and a back cylinder member which communicates with the rear end of the front cylinder member and is provided in a fixed manner. The driving device can drive the front cylinder member in the front-back direction.

Preferably, the back cylinder member has a small diameter chamber which communicates with the rear end of the front cylinder member, and a large diameter chamber which communicates with the small diameter chamber and has a larger diameter than the small diameter chamber. The injection cylinder device further has a boosting piston having a small diameter portion which can slide in the small diameter chamber and a large diameter portion which can slide in the large diameter chamber formed therein.

Preferably, the injection cylinder device further has a communicating tube which is fixed to the rear end of the front cylinder member, is inserted into the back cylinder member so that it can relatively move, and makes the front cylinder member and the back cylinder member communicate with each other.

Preferably, the injection cylinder device further has a communicating tube which is fixed to the rear end of the front cylinder member, into which the back cylinder member is inserted so that it can relatively move, and which makes the front cylinder member and the back cylinder member communicate with each other.

Preferably, the inside diameter of the communicating tube is less than the inside diameter of the front cylinder member. The front end of the communicating tube defines the backward limit of the injection piston with respect to the front cylinder member by abutting against the rear end of the injection piston.

Preferably, the inside diameter of the communicating tube is the inside diameter of the front cylinder member or more. The cylinder part has, at the rear end of the front cylinder member, a stopper provided partially with respect to the circumferential direction of the front cylinder member which projects out toward the inside of the front cylinder member and defines the backward limit of the injection piston with respect to the front cylinder member by abutting against the rear end of the injection piston.

Preferably, the driving device has a screw mechanism which has a screw shaft extending in the front-back direction and a nut which is screwed with the screw shaft, one of the screw shaft and the nut being fixed to the front cylinder member; and an electric motor which makes the other of the screw shaft and the nut rotate.

A molding apparatus according to one aspect of the present invention is provided with any of the injection devices described above.

### Advantageous Effects of Invention

According to the above configuration, injection force can be suitably received.

### BRIEF DESCRIPTION OF DRAWINGS

FIG. 1 is a side view which schematically shows a configuration of principal parts of a die cast machine according to an embodiment of the present invention.

FIG. 2 is a cross-sectional view seen from an upper part which schematically shows a configuration of principal parts of an injection device of the die cast machine in FIG. 1.

FIG. 3 is an enlarged view of a front end and a rear end of a communicating tube of the injection device in FIG. 2.

FIG. 4 is a diagram which explains the operation of the injection device in FIG. 2.

FIG. 5A and FIG. 5B are schematic diagrams for explaining retraction of an injection piston and a boosting piston.

FIG. 6 is a cross-sectional view seen from an upper part which schematically shows a configuration of principal parts of an injection device according to a second embodiment of the present invention.

### DESCRIPTION OF EMBODIMENTS

### First Embodiment

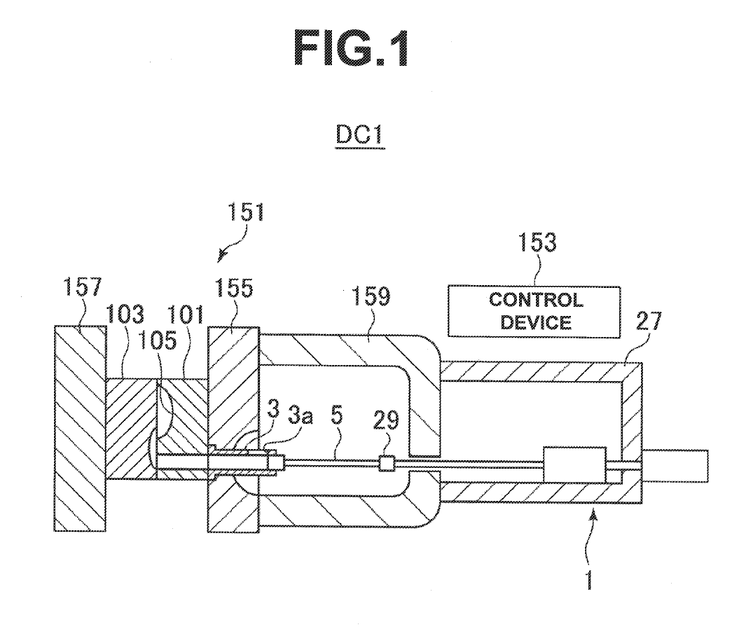

FIG. 1 is a side view (partially including a cross-sectional view) which schematically shows a configuration of principal parts of a die cast machine DC1 according to an embodiment of the present invention.

Note that, in the following description, sometimes the left side in the drawing in FIG. 1 (a direction in which a plunger 5 advances when extruding molten metal into a cavity 105 by the plunger 5) will be referred to as “forward”, and the right side in the drawing in FIG. 1 will be referred to as “backward”.

The die cast machine DC1, for example, has a mold clamping device 151 which clamps a fixed mold 101 and a moving mold 103, an injection device 1 which injects and fills a molten metal (metal material in molten state) as a molding material (material) into a cavity 105 which is configured by the fixed mold 101 and moving mold 103 which is clamped by the mold clamping device 151, a not shown extrusion device which extrudes a molded die cast article (molded article) from the fixed mold 101 or moving mold 103, and a control device 153 for controlling these devices. Note that, the control device 153 may also be grasped as configuring portions of each of the devices such as the injection device.

The mold clamping device 151, for example, has a not shown base, a fixed die plate 155 which is fixed on the base and holds the fixed mold 101, and a movable die plate 157 which can move in a mold opening and closing direction on the base and holds the moving mold 103. Note that, in the present application, “fixed” includes not only a case where two members are connected, but also a case where two members are integrally formed.

To the fixed die plate 155, an injection frame 159 is fixed. The injection frame 159 may be given a C-type (C-shape), D-type (D-shape), or another suitable type (shape). Note that, the injection frame 159, as will be explained later, contributes to support of the member of the injection device 1 and so on, therefore may be grasped as a portion of the injection device 1 as well.

(Configuration of Injection Device)

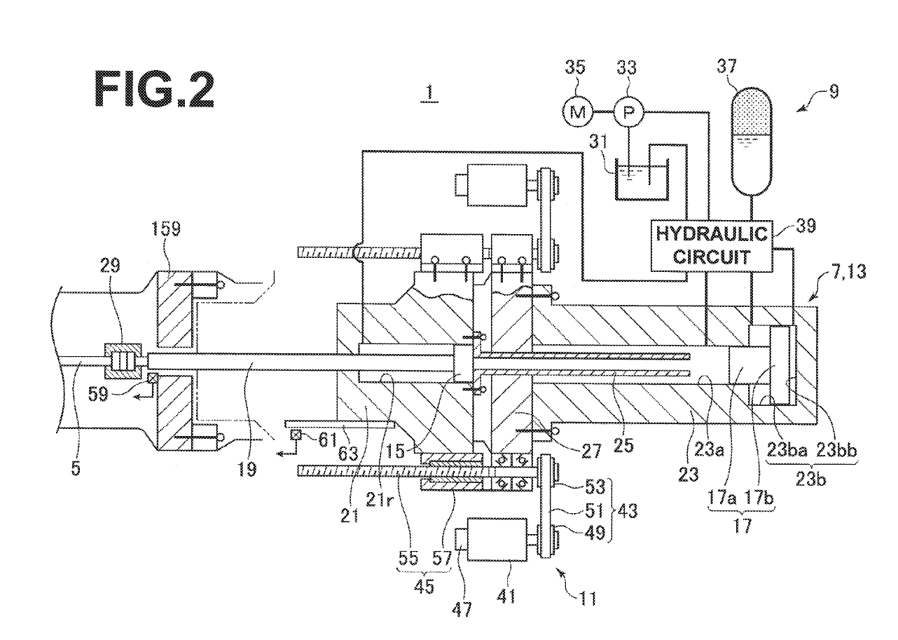

FIG. 2 is a cross-sectional view seen from an upper part schematically showing the configuration of principal parts of the injection device 1.

The injection device 1, for example, has a sleeve 1 (FIG. 1) which is communicated with the cavity 105, a plunger 5 which extrudes the molten metal in the sleeve 3 into the cavity 105, an injection cylinder device 7 which drives the plunger 5, a hydraulic apparatus 9 which supplies a working fluid to the injection cylinder device 7, and a driving device 11 which drives the plunger 5.

The configurations of the sleeve 3 and plunger 5 may be the same as known configurations. The sleeve 3 is for example provided so as to be inserted into the fixed die plate 155. Note that, the sleeve 3 may be inserted into the fixed mold 101 as well. The plunger 5 has a plunger tip (FIG. 1) which slides through the sleeve 3 and a plunger rod which is fixed to the plunger tip.

By the plunger 5 sliding toward the cavity 105 (moving forward) in the sleeve 3 in a state where a molten metal is supplied into the sleeve 3 from a supply port 3a (FIG. 1) formed in the sleeve 3, the molten metal is injected and filled into the cavity 105.

The injection cylinder device 7 is for example configured by a boosting cylinder. That is, the injection cylinder device 7 has a cylinder part 13, an injection piston 15 and a boosting piston 17 which can slide inside the cylinder part 13 and a piston rod 19 which extends forward (to the plunger 5 side) from the injection piston 15.

One of characteristic features of this injection cylinder device 7 is that the cylinder part 13 has a front cylinder member 21 which is movable in a front-back direction and a back cylinder member 23 which is positioned at the back of that and is provided in a fixed manner. The front cylinder member 21 and the back cylinder member 23 are communicated with each other by for example a communicating tube 25. These specific configurations are for example as follows.

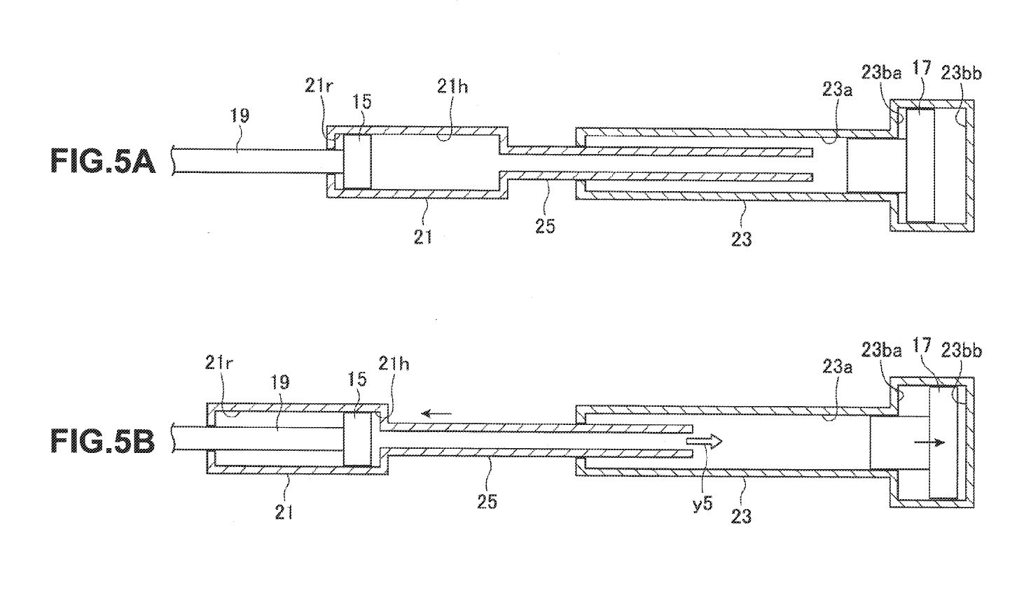

The front cylinder member 21 accommodates the injection piston 15 so that it can slide in the front-back direction. The piston rod 19 extends forward from the front cylinder member 21. The rear end of the front cylinder member 21 is not closed. The injection piston 15 can partition the internal portion of the front cylinder member 21 into a rod side chamber 21r on the front side and a head side chamber 21h on the rear side (for notation, see FIG. 5) on the back side.

As shown in FIG. 2, when the injection piston 15 is positioned at the backward limit, the head side chamber 21h may be eliminated as well. Note, below, for convenience, including such a state as well, when the working fluid is supplied to the back of the injection piston 15, it will be sometimes be expressed that the working fluid is supplied to the head side chamber 21h.

By supplying the working fluid to the head side chamber 21h, the injection piston 15 can be relatively moved forward with respect to the front cylinder member 21. Further, by supplying the working fluid to the rod side chamber 21r, the injection piston 15 can be relatively moved backward with respect to the front cylinder member 21.

The front cylinder member 21 may be provided so as to be movable in the front-back direction with respect to the fixed member such as the fixed die plate 155 according to a suitable method. For example, an intermediate block 27 (FIG. 1) which is fixed to the injection frame 159 may be provided, and a known linear guide (not shown) which extends in the front-back direction may be laid between the upper surface of the lower portion of the intermediate block 27 and the front cylinder member 21.

The back cylinder member 23 has a small diameter chamber 23a which is positioned at the front cylinder member 21 side and a large diameter chamber 23b which is communicated with the back of the small diameter chamber 23a and has a larger diameter than the small diameter chamber 23a. On the other hand, the boosting piston 17 has a small diameter portion 17a which can slide in the small diameter chamber 23a and a large diameter portion 17b which can slide in the large diameter chamber 23b. The large diameter portion 17b partitions the large diameter chamber 23b into a front side chamber 23ba on the front and a back side chamber 23bb on the back.

By supplying the working fluid to the back side chamber 23bb in a state where the front side chamber 23ba is made the tank pressure, the working fluid in the small diameter chamber 23a can be boosted in accordance with the difference of pressure receiving areas on the front and back of the boosting piston 17. Further, by supplying the working fluid to the small diameter chamber 23a and/or front side chamber 23ba, the boosting piston 17 can be retracted.

The back cylinder member 23 may be provided so that it cannot move with respect to the fixed die plate 155 or another fixed member according to a suitable method. For example, the back cylinder member 23 may be fixed to the rear end part of the intermediate block 27 explained above by screws or the like. Note that, FIG. 2 exemplifies a case where the rear end part of the intermediate block 27 is used also as the front end part of the back cylinder member 23. In the following description, the rear end part of the intermediate block 27 will be sometimes expressed as a portion of the back cylinder member 23.

The communicating tube 25 is, for example, a substantially tubular member which does not have flexibility. The front end thereof is fixed to the rear end of the front cylinder member 21. Further, the internal portion of the communicating tube 25 is communicated with the internal portion of the front cylinder member 21. On the other hand, the communicating tube 25 is inserted so that the back side can relatively move in the front-back direction with respect to the back cylinder member 23. Due to this, the front cylinder member 21 and the back cylinder member 23 are communicated with each other. Further, in a state where the communication is maintained, the front cylinder member 21 is movable in the front-back direction with respect to the back cylinder member 23.

The injection cylinder device 7 is arranged coaxially (in series) on the back with respect to the plunger 5. The tip end of the piston rod 19 is connected through a coupling 29 to the rear end of the plunger 5. Accordingly, the plunger 5 moves forward and backward as well accompanied with a forward and backward movement of the piston rod 19.

The hydraulic apparatus 9, for example, has a tank 31 which stores the working fluid, a pump 33 which pumps out the working fluid in the tank 31, a pump-use electric motor 35 which drives the pump 33, an accumulator 37 which supplies the accumulated working fluid, and a hydraulic circuit 39 which connects these elements and the injection cylinder device 7 to each other.

The tank 31 is for example an open tank and holds the working fluid under an atmospheric pressure. The tank 31 for example transfers working fluid with the injection cylinder device 7 through the hydraulic circuit 39 or the like, and supplies the working fluid to the accumulator 37 through the pump 33 and hydraulic circuit 39.

The pump 33 may a rotary pump such as a gear pump or a vane pump which discharges the working fluid by rotation of a rotor or may be a plunger pump such as an axial type plunger pump or a radial type plunger pump which discharges the working fluid by reciprocation of the piston. The pump 33 may be configured by a constant capacity pump in which an amount of discharge in one period of motion of the rotor or piston is fixed or may be configured by a variable capacity pump in which the amount of discharge is variable. Further, a pump 33 only has to discharge the working fluid in one direction, but it may also be structured the same as a bidirectional (two-direction) pump as well.

The pump-use electric motor 35 is for example a rotating type electric motor. The pump-use electric motor 35 may be a D.C. motor or A.C. motor, or may be an induction motor or synchronous motor. The pump-use electric motor 35 may function as a constant-speed motor which is provided in an open loop or may function as a servo motor which is provided in a closed loop.

The accumulator 37 may be configured by a gravimetric system, spring type, gas pressure type (including air pressure type), cylinder type, bladder type, or other suitable type of accumulator. For example, the accumulator 37 is a gas pressure type, cylinder type, or bladder type accumulator, and the pressure is accumulated therein by compression of gas (for example air or nitrogen) held in the accumulator 37. The pressurized working fluid is supplied through the hydraulic circuit 39 to the injection cylinder device 7.

The hydraulic circuit 39 has a plurality of passages which connect the injection cylinder device 7, tank 31, pump 33, and accumulator 37 to each other and a plurality of valves which control the flow of the working fluid in the plurality of passages. The plurality of passages are for example configured by steel pipes, flexible hoses, or metal blocks. The plurality of valves are for example non-pilot type or pilot-type check valves, switching valves, or servo valves controlling the flow rate.

The portions of the hydraulic apparatus 9 may be suitably provided so as to move with the front cylinder member 21 or may be provided in a fixed manner in the same way as the back cylinder member 23. For example, preferably the tank 31, pump 33, and pump-use electric motor 35 are provided in a fixed manner. Further, all or most of the plurality of valves provided in the hydraulic circuit 39 are preferably provided in a fixed manner.

The accumulator 37 may be provided movable together with the front cylinder member 21 or may be provided in a fixed manner. From the viewpoint of lightening the weight of the movable part including the front cylinder member 21, the accumulator 37 is preferably provided in a fixed manner. Further, in the present embodiment, the supply of the working fluid to the head side chamber 21h is for example carried out through the small diameter chamber 23a and communicating tube 25. In such a case, from the viewpoint of simplification of the passages of the working fluid, preferably the accumulator 37 is provided in a fixed manner. In a case where a port for supplying the working fluid to the head side chamber 21h is formed in the front cylinder member 21, the accumulator 37 may be provided so as to move together with the front cylinder member 21 as well.

The driving device 11 is for example configured so as to drive the front cylinder member 21 in the front-back direction by the electric motor. Specifically, the driving device 11 has a rotating type drive-use electric motor 41, a transmission mechanism 43 which transmits the rotation of the drive-use electric motor 41, and a screw mechanism 45 which transforms the rotation transmitted by the transmission mechanism 43 to translational motion and transmits the same to the front cylinder member 21. The driving device 11 for example has two sets of combinations of these drive-use electric motor 41, transmission mechanism 43, and screw mechanism 45 so that they are left-right symmetric.

The drive-use electric motor 41 may be a D.C. motor or A.C. motor or may be an induction motor or synchronous motor. The drive-use electric motor 41 is preferably an electric motor which is equipped with a brake. The drive-use electric motor 41 is for example configured as a servo motor and configures a servo mechanism together with an encoder 47 which detects the rotation of the drive-use electric motor 41 and a not shown servo driver which supplies electric power to the drive-use electric motor 41.

Note that, in the explanation of the operation which will be given later, when the drive-use electric motor 41 stops, the drive-use electric motor 41 may be rendered a torque-free state, may be controlled so as to stop at a constant position, or may be configured so as to include a brake and the brake used. A suitable method of stopping may be selected in accordance with the situation in which the drive-use electric motor 41 is stopped.

The transmission mechanism 43 is for example configured by a pulley-belt mechanism which has a first pulley 49 which is fixed to the output shaft of the drive-use electric motor 41, a second pulley 53 which is fixed to the screw mechanism 45, and a belt 51 hung upon the first pulley 49 and second pulley 53. Accordingly, when the drive-use electric motor 41 rotates, its rotation is transmitted through the transmission mechanism 43 to the screw mechanism 45.

The screw mechanism 45 is for example configured by a ball screw mechanism or sliding screw mechanism and has a screw shaft 55 and a nut 57 screwed with the screw shaft 55.

The screw shaft 55 is arranged parallel to the plunger 5. Further, the screw shaft 55 is limited in movement in an axial direction and is permitted to rotate about its axis due to for example attachment on the lateral side of the rear end part of the intermediate block 27 by a suitable bearing or the like. On the other hand, the nut 57 is made movable in the axial direction together with the front cylinder member 21 and is limited in rotation about its axis by for example being fixed to the front cylinder member 21 or the like. Accordingly, when the screw shaft 55 is rotated, the nut 57 moves in a direction parallel to the plunger 5 and consequently the front cylinder member 21 moves in the front-back direction.

The control device 153, for example, although not particularly illustrated, includes a CPU, ROM, RAM, external memory unit, input circuit, and output circuit. The control device 153 outputs control signals for controlling each of parts based on various types of input signals which are input.

The control device 153 receives signals from for example a not shown input device which receives input operations by an operator, an encoder 47, a first position sensor 59 for detecting the position of the plunger 5, a second position sensor 61 for detecting the position of the front cylinder member 21, and a not shown pressure sensor which detects the pressure of the working fluid at a suitable position in the hydraulic system.

The control device 153 outputs signals to for example a not shown display unit which displays information to the user, a not shown driver which supplies electric power to the drive-use electric motor 41, a not shown driver which supplies electric power to the pump-use electric motor 35, and a hydraulic circuit 39.

The first position sensor 59 for example configures a linear encoder together with a not shown scale portion. For example, the first position sensor 59 is provided on the front of the injection cylinder device 7 (for example on the injection frame 159) in a fixed manner, and the scale portion is provided in the piston rod 19 and extends in its axial direction. Further, the first position sensor 59 detects the position of the scale portion which moves accompanied with the movement of the piston rod 19 to indirectly detect the position of the plunger 5. Note that, the first position sensor 59 or control device 153 can differentiate the detected position to detect the speed.

The second position sensor 61 for example configures a linear encoder together with the scale portion 63. For example, the second position sensor 61 is provided on the lateral side of the front cylinder member 21 (for example on the intermediate block 27) in a fixed manner, and the scale portion 63 is fixed to the front cylinder member 21 and extends in the front-back direction. Further, the second position sensor 61 detects the position of the scale portion 63 which moves accompanied with the movement of the front cylinder member 21 to detect the position of the front cylinder member 21. Note that, the second position sensor 61 or control device 153 can differentiate the detected position to detect the speed.

The pressure sensor is provided at a suitable position in the hydraulic system. For example, although not particularly illustrated, a pressure sensor which detects the pressure of the small diameter chamber 23a (head side chamber 21h) and a pressure sensor which detects the pressure of the rod side chamber 21r are provided. The control device 153 can use the detection values of these pressure sensors as the basis to specify a pressure which is applied to the molten metal by the plunger 5. Further, for example, although not particularly illustrated, a pressure sensor which detects the pressure of the accumulator 37 is provided. The control device 153 can use that detection value as the basis to judge the completion of filling of the accumulator 37.

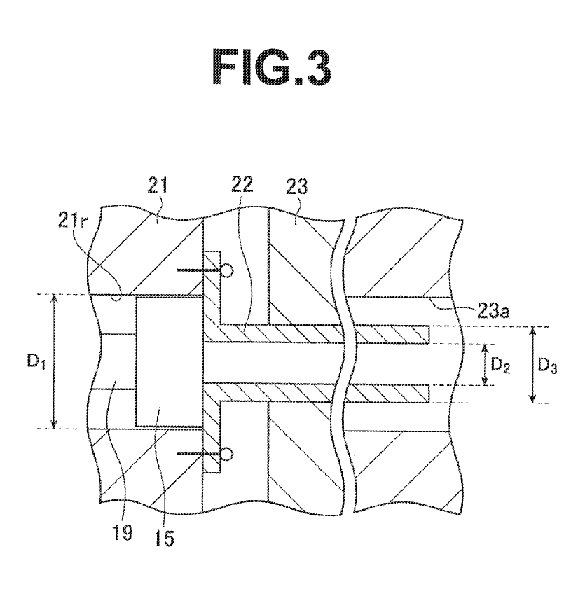

FIG. 3 is an enlarged view of a front end and rear end of the communicating tube 25.

An outside diameter D₃ of the communicating tube 25 is for example roughly constant over its entire length and is smaller than the inside diameter of the small diameter chamber 23a. Further, the communicating tube 25 is made slidable with respect to the back cylinder member 23 in an opening which is formed on the rear end of the back cylinder member 23. Note that, the outside diameter D₃ may be the same as the inside diameter of the small diameter chamber 23a as well.

An inside diameter D₂ of the communicating tube 25 is for example roughly constant over its entire length and is less than an inside diameter D₁ of the front cylinder member 21. Accordingly, the rear end of the front cylinder member 21 is opened by an opening which has the inside diameter D₂ as its diameter. Further, the front end of the communicating tube 25 functions as a stopper which abuts against the rear end of the injection piston 15 and defines the backward limit of the injection piston 15.

The pressure of the working fluid in the head side chamber 21h acts upon the front end face of the communicating tube 25. The communicating tube 25 is fixed to the front cylinder member 21. Accordingly, the area of the front end face of the communicating tube 25 substantially becomes the pressure receiving area of the front cylinder member 21 with respect to the backward pressure of the working fluid in the head side chamber 21h. This pressure receiving area is (cross-sectional area of head side chamber 21h)−(cross-sectional area of inside of communicating tube 25). If the internal portions of the head side chamber 21r and communicating tube 25 are circular cross-sections, it is (πD₁²−πD₂²)/4.

On the other hand, in the opening having the inside diameter D₂ which is formed at the rear end of the front cylinder member 21 by the communicating tube 25, the backward pressure of the working fluid does not act upon the front cylinder member 21 (communicating tube 25), but acts upon the back cylinder member 23 through the communicating tube 25. More strictly, the pressure first acts upon the front end face of the boosting piston 17. Then, the force applied to the boosting piston 17 is for example transmitted to a portion in the back cylinder member 23 which abuts against the rear end of the boosting piston 17 and defines the backward limit of the boosting piston 17.

Accordingly, when supplying the working fluid to the head side chamber 21h and moving the injection piston 15 forward, the reaction force (injection force) is partially received at the front cylinder member 21, while the remainder is received by the back cylinder member 23. The larger the area of the rear end of the front cylinder member 21 which is opened with respect to the back cylinder member 23 (cross-sectional area of the internal portion of the communicating tube 25), the smaller the reaction force which is received by the front cylinder member 21.

The opening area of the rear end of the front cylinder member 21 may be made a suitable size. For example, the opening area may be ¼ or more or ½ or more of the cross-sectional area of the front cylinder member 21.

The rear side portion of the communicating tube 25 is inserted into the back cylinder member 23. The forward pressure of the working fluid in the small diameter chamber 23a acts upon the rear end face of the communicating tube 25. The head side chamber 21h and the small diameter chamber 23a are communicated with each other and basically have the same pressure. Accordingly, at least a portion of the reaction force which is received by the front cylinder member 21 is cancelled by the force which is received by the rear end face of the communicating tube 25 from the working fluid.

The larger the area of the rear end face of the communicating tube 25, the larger the cancelling force. If the communicating tube 25 is circular, the area of the rear end face is (πD₃²−πD₂²)/4. Further, when the area of the rear end face of the communicating tube 25 becomes equal to the area of a portion of the front end face of the communicating tube 25, the portion being exposed at the head side chamber 21h, the reaction force which is received by the front cylinder member 21 is completely cancelled. That is, in the present embodiment, if D₁=D₃, the reaction force which is received by the front cylinder member 21 is completely cancelled.

(Operation of Injection Device)

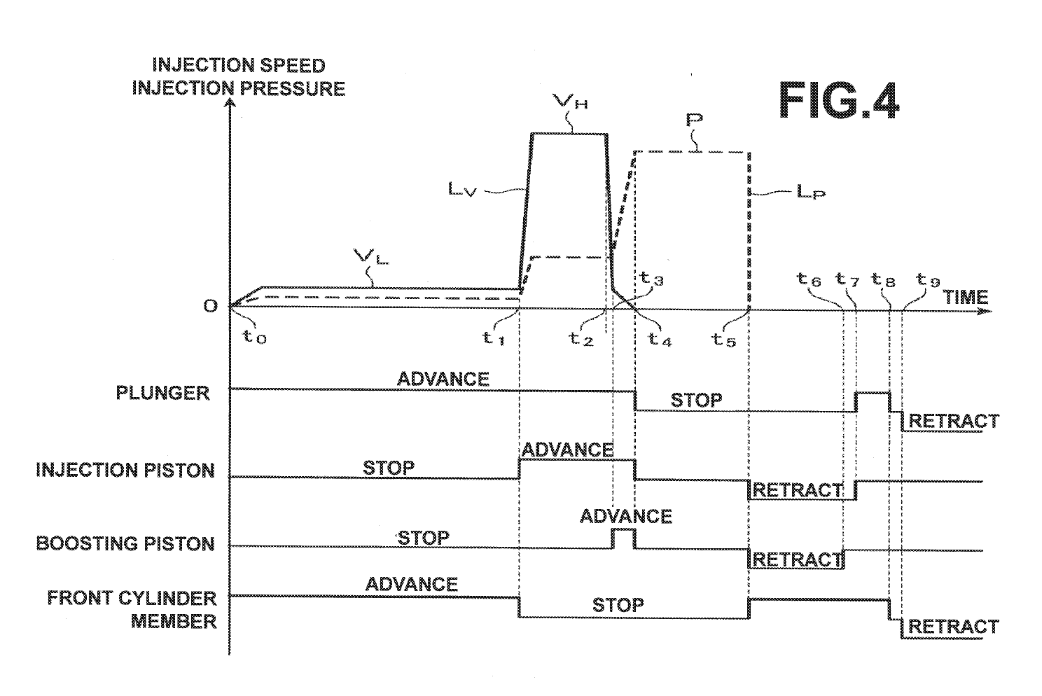

FIG. 4 is a diagram for explaining the operation of the injection device 1. In FIG. 4, an abscissa indicates time. Further, a solid line L_{V} indicates the change of the injection speed, and a broken line L_{P} indicates the change of the injection pressure. In a graph in which the solid line L_{V} and broken line L_{P} are drawn, an ordinate indicates the magnitudes of the injection speed and injection pressure. Further, in the lower part of the graph, operations of the plunger 5, injection piston 15, boosting piston 17, and front cylinder member 21 are shown. Note that, “ADVANCE”, “STOP”, and “RETRACT” of the injection piston 15 in FIG. 4 mean its relative advance, stop, and retraction relative to the front cylinder member 21.

The injection device 1 schematically performs low speed injection, high speed injection, and increase of pressure (boosting) in that order. That is, in an initial stage of injection, the injection device 1 moves the plunger 5 forward at a relatively low speed (speed V_{L}) in order to prevent entrainment of air by the molten metal, next moves the plunger 5 forward at a relatively high speed (speed V_{H}) from the viewpoint of filling the molten metal without delay in solidification of the molten metal. After that, in order to eliminate shrinkage cavities of the molded article, the molten metal in the cavity is raised in pressure by the force in the advance direction of the plunger 5. Specifically, this is as follows.

(Low Speed Injection: t0 to t1)

Immediately before the start of low speed injection, the injection device 1 for example becomes a state shown in FIG. 1. That is, the front cylinder member 21 (nut 57), injection piston 15, and boosting piston 17 are positioned at initial positions such as the backward limit. Further, the drive-use electric motor 41 and pump-use electric motor 35 stop. The various types of valves of the hydraulic circuit 39 are for example basically controlled so as to prohibit the flow of the working fluid.

If a predetermined low speed injection start condition is satisfied, for example if clamping of the fixed mold 101 and moving mold 103 ends and the molten metal is supplied to the sleeve 3, the injection device 1 moves the front cylinder member 21 forward. Due to this, the plunger 5 advances, and low speed injection is carried out.

Specifically, the control device 153 drives the drive-use electric motor 41 at a predetermined speed. That driving force is transmitted through the transmission mechanism 43 and screw mechanism 45 to the front cylinder member 21. On the other hand, the plunger 5 is fixed to the injection piston 15, the rear end of the injection piston 15 abuts against the front end of the communicating tube 25, and the communicating tube 25 is fixed to the front cylinder member 21. Accordingly, the plunger 5 advances accompanied with the advance of the front cylinder member 21.

Along with the advance of the front cylinder member 21, in the cylinder part 13, the capacity behind the injection piston 15 increases. Specifically, the capacity behind the injection piston 15 is enlarged by an amount corresponding to the capacity and volume of a portion of the communicating tube 25, the portion moving from the internal portion of the back cylinder member 23 to the external portion. As a result, behind the injection piston 15 in the cylinder part 13, the working fluid becomes insufficient.

This short working fluid may be suitably replenished. For example, the working fluid may be replenished from the tank 31 by a negative pressure, or the working fluid may be replenished by the pump 33. Note that, when the working fluid is replenished by the pump 33, the amount of supply of the working fluid is adjusted so that the injection piston 15 does not relatively move forward relative to the front cylinder member 21 due to the pressure of the working fluid behind the injection piston 15. This adjustment is for example carried out by the control of the rotation speed of the pump 33. It may be controlled by a servo valve of a meter-in circuit as well in a case where a meter-in circuit is provided.

The speed of the plunger 5 is controlled by adjustment of the rotation speed of the drive-use electric motor 41. For example, the control device 153 feedback controls the rotation speed of the drive-use electric motor 41 based on the speed of the plunger 5 which is detected by the first position sensor 59 (may be second position sensor 61 as well). Note that, multistage control of the speed of the plunger 5 may be carried out as well.

(High Speed Injection: t1 to t2)

The injection device 1 makes the injection piston 15 relatively move forward with respect to the front cylinder member 21 when the position of the plunger 5 based on the detection value of the first position sensor 59 reaches a predetermined high speed switching position. Due to this, the plunger 5 advances, and high speed injection is carried out.

Specifically, the control device 153 closes off the head side chamber 21h and the tank 31 or pump 33 and controls the hydraulic circuit 39 so as to supply the working fluid from the accumulator 37 to the back of the injection piston 15. Due to this, the injection piston 15 moves forward at a relatively high speed with respect to the front cylinder member 21.

Note that, the working fluid which is discharged from the rod side chamber 21r accompanied with the forward movement of the injection piston 15 may be discharged to the tank 31 or may be recirculated to the back of the injection piston 15 through the hydraulic circuit 39 (not shown runaround circuit).

The speed of the plunger 5 is for example controlled according to the flow rate control of the injection cylinder device 7. Specifically, the control device 153 uses the speed of the plunger 5 which is detected by the first position sensor 59 as the basis to feedback control the degree of opening of a servo valve of a meter-in circuit and/or a servo valve of a meter-out circuit in the hydraulic circuit 39, which are not shown.

In the high speed injection, the front cylinder member 21 may be stopped or its forward movement may be continued according to the driving force of the drive-use electric motor 41. FIG. 4 exemplifies a state where it is stopped. In the case of stopping, the control device 153 for example operates the brake of the drive-use electric motor 41. Further, in the case where the forward movement is continued, the speed of the front cylinder member 21 may be the same as the low injection speed or may be slower or faster than the low injection speed.

Note that, in the case where the front cylinder member 21 is stopped, the speed v₁ of the plunger 5 is defined according to the amount of supply of the working fluid from the accumulator 37 to the back of the injection piston 15 and the pressure receiving area of the back of the injection piston 15. That is, when the amount of supply of the working fluid is V (m³/s) and the pressure receiving area of the back of the injection piston 15 is πD₁²/4 (m²), the speed of the injection piston 15 is v₁=V/(πD₁²/4) (m/s).

Further, in the case where the forward movement of the front cylinder member 21 continues, as described in the explanation of the low speed injection, according to the forward movement of the front cylinder member 21, the capacity of the back of the cylinder part 13 (communicating tube 25 and back cylinder member 23) is enlarged. The working fluid which flows into the head side chamber 21h is reduced by that amount. Accordingly, the speed v₂ of the plunger 5 does not become a simple sum (v₁+v₃) of the speed v₁ in the case where the front cylinder member 21 is stopped and the speed v₃ of the front cylinder member 21. More specifically, when ignoring the influence of the amount of discharge of the working fluid of the rod side chamber 21r or the like, if the cross-sectional area of the enlarged capacity (πD₃²/4 in the present embodiment) is larger than the pressure receiving area (πD₁²/4) of the back of the injection piston 15, v₂ is smaller than v₁. If they are equal, v₂ is equal to v₁, and if the former is smaller than the latter, v₂ is larger than v₁.

(Deceleration Injection: t2 to t3)

When the molten metal is filled in the cavity 105 to a certain extent, the plunger 5 is decelerated by receiving the reaction force from that filled molten metal. On the other hand, the injection pressure rapidly increases. Note that, the operation of each part is the same as that at high speed injection. Note, in order to mitigate the impact at the time of filling, suitable deceleration control may be carried out by a not shown meter-out circuit or the like when for example the plunger 5 reaches the predetermined deceleration position or when otherwise the predetermined deceleration start condition is satisfied.

(Boosting: t3 to t4)

When a predetermined boosting start condition is satisfied, the control device 153 controls the hydraulic circuit 39 so as to start the boosting process. The boosting start condition is for example that the injection pressure based on the detection value of a not shown pressure sensor which detects the pressure of the head side chamber 21h (and a not shown pressure sensor detecting the pressure of the rod side chamber 21r according to need) reaches a predetermined value or that the detection position of the plunger 5 detected by the first position sensor 59 reaches a predetermined position.

The hydraulic circuit 39, for the start of boosting, allows release of the working fluid from the accumulator 37 to the rear side chamber 23bb, allows discharge of the working fluid from the front side chamber 23ba to the tank 31, prohibits discharge of the working fluid from the head side chamber 21h, and allows discharge of the working fluid from the rod side chamber 21r to the tank 31. Due to this, the pressure of the head side chamber 21h is boosted by the boosting piston 17, the injection pressure rises, and the injection pressure reaches the final pressure (pressure P). Further, the injection speed becomes 0 since the molten metal is completely filled in the cavity 105. Note that, multistage control of the injection pressure may be carried out as well.

(Pressure Retention: t4 to t5)

The control device 153 maintains the state where the injection pressure has become the final pressure. During this, the molten metal is cooled and solidifies. When the molten metal solidifies, the control device 153 controls the hydraulic circuit 39 so as to stop the supply of the liquid pressure from the accumulator 37 to the rear side chamber 23bb. That is, the pressure retention ends.

The control device 153 may suitably judge whether the molten metal has solidified. For example, the control device 153 judges whether the molten metal has solidified according to whether a predetermined time has passed from a predetermined point of time such as a point of time when the final pressure is obtained or the like.

(Retraction of Injection Piston and Boosting Piston: t5 to t7)

After the end of pressure retention, the control device 153 controls the drive-use electric motor 41 so as to move the front cylinder member 21 forward.

FIG. 5A and FIG. 5B are schematic diagrams for explaining the operations of pistons and the flow of the working fluid at this time. FIG. 5A shows a state at the time of start of forward movement (t5) of the front cylinder member 21, and FIG. 5B shows a state at a point of time (t6) when the forward movement of the front cylinder member 21 roughly ends.

The forward movement of the plunger 5 is limited by the solidified molten metal (more specifically, biscuit). That is, the forward movement of the injection piston 15 is limited. Accordingly, when the front cylinder member 21 is moved forward, the injection piston 15 relatively retracts with respect to the front cylinder member 21. From another viewpoint, the capacity of the head side chamber 21h is reduced. Note that, at this time, the control device 153 controls the hydraulic circuit 39 so that inflow of the working fluid from the tank 31 or the like to the rod side chamber 21r is allowed.

On the other hand, when the front cylinder member 21 moves forward, in the same way as the low speed injection, the capacity is enlarged on the back of the cylinder part 13 (communicating tube 25 and back cylinder member 23). In the present embodiment, the cross-sectional area of this enlarged capacity is smaller than the cross-sectional area of the head side chamber 21h.

Accordingly, between the injection piston 15 and the boosting piston 17, the capacity is reduced by a difference between the reduced amount of the capacity of the head side chamber 21h and the enlarged amount of the capacity of the back thereof.

The control device 153 controls the hydraulic circuit 39 so that the discharge of the working fluid between the injection piston 15 and the boosting piston 17 is prohibited, the discharge of the working fluid of the back side chamber 23bb is allowed, and inflow of the working fluid from the tank 31 or the like to the front side chamber 23ba is allowed. As a result, when the capacity of the back of the injection piston 15 is reduced, as indicated by an arrow y5, the working fluid flows from the communicating tube 25 to the small diameter chamber 23a, and the boosting piston 17 retracts.

Note that, before the point of time (t7) when the injection piston 15 reaches the backward limit, preferably the boosting piston 17 reaches the backward limit (t6). When the injection piston 15 previously reaches the backward limit, the working fluid may be supplied to the small diameter chamber 23a by the pump 33.

(Ejection Tracking: t7 to t8)

Return to FIG. 4. When the injection piston 15 reaches the backward limit (abuts against the front end of the communicating tube 25), the driving force of the driving device 11 is transmitted to the injection piston 15 through the front cylinder member 21. On the other hand, the control device 153 makes a not shown clamping device open the mold and ejects the molded article from the fixed mold 101 by a not ejection device. Accordingly, the plunger 5 contributes to the ejection of the molded article from the fixed mold 101.

(Plunger Retraction: T9 on)

After that, the control device 153 controls the driving device 11 so as to retract the front cylinder member 21. At this time, fluid pressure may be suitably given to the rod side chamber 21r so that the injection piston 15 will not move forward relative to the front cylinder member 21.

As described above, in the present embodiment, the injection device 1 has the injection cylinder device 7 which is connected to the plunger 5 and has the driving device 11 which can drive the plunger 5 to move forward through the injection cylinder device 7. The cylinder part 13 of the injection cylinder device 7 has the front cylinder member 21 which accommodates the injection piston 15 so that it can slide in the front-back direction, is opened in the rear end, and can move in the front-back direction. Further, the cylinder part 13 has the back cylinder member 23 which is communicated with the rear end of the front cylinder member 21 and is provided in a fixed manner. The driving device 11 can drive the front cylinder member 21 in the front-back direction.

Accordingly, in the reaction force (injection force) which is generated when supplying the working fluid to the back of the injection piston 15, an amount corresponding to the opening area of the rear end of the front cylinder member 21 is received by the back cylinder member 23 which is provided in a fixed manner. As a result, for example, the load of the driving device 11 is lightened. Further, for example, acceleration at a time of high speed is suitably carried out.

Further, in the present embodiment, the back cylinder member 23 has the small diameter chamber 23a which is communicated with the rear end of the front cylinder member 21 and the large diameter chamber 23b which is communicated with the small diameter chamber 23a and has a larger diameter than the small diameter chamber 23a. The injection cylinder device 7 further has the boosting piston 17 in which the small diameter portion 17a capable of sliding in the small diameter chamber 23a and the large diameter portion 17b capable of sliding in the large diameter chamber 23b are formed.

Accordingly, in the reaction force generated due to the pressure of the head side chamber 21h being made high at the time of boosting, an amount corresponding to the opening area of the rear end of the front cylinder member 21 is received by the back cylinder member 23 which is provided in a fixed manner. As a result, for example, the load of the driving device 11 is lightened. Further, it is not necessary to move the boosting piston 17 and a portion accommodating this (the back cylinder member 23) and so on unlike the case where a cylinder part does not divided, therefore the mass which is moved by the driving device 11 at the time of low speed injection or the like is reduced. On this point as well, reduction of the load of the driving device 11 can be expected.

Further, in the present embodiment, the injection cylinder device 7 further has the communicating tube 25 which is fixed to the rear end of the front cylinder member 21, is inserted into the back cylinder member 23 so that it can relatively move, and makes the front cylinder member 21 and the back cylinder member 23 communicate with each other.

Accordingly, for example, in comparison with a case where the front cylinder member 21 and the back cylinder member 23 are communicated with each other by a flexible hose (this case is included in the invention of the present application as well), it is ease to make the opening of the back of the front cylinder member 21 larger by making the diameter of the communicating tube 25 larger. As a result, for example, it becomes easier to receive the injection force by the back cylinder member 23. Further, for example, it becomes easier to secure the flow rate of the working fluid which flows between the front cylinder member 21 and the back cylinder member 23, therefore the supply of the working fluid of the accumulator 37 through the back cylinder member 23 to the front cylinder member 21 is facilitated. Consequently, fixed placement of the accumulator 37 is facilitated as well. Further, the rear end of the communicating tube 25 is exposed in the back cylinder member 23. Therefore, as already explained, when the working fluid is supplied to the head side chamber 21h, at least a portion of the reaction force received by the front cylinder member 21 can be cancelled by the pressure acting upon the rear end of the communicating tube 25.

Further, in the present embodiment, the inside diameter of the communicating tube 25 is less than the inside diameter of the front cylinder member 21, and the front end of the communicating tube 25 defines the backward limit of the injection piston 15 with respect to the front cylinder member 21 due to the front end of the communicating tube 25 abutting against the rear end of the injection piston 15.

Accordingly, the communicating tube 25 is used also as the member for defining the backward limit of the injection piston 15. As a result, the configuration is simplified. Further, in a state where the injection piston 15 abuts against the communicating tube 25, pressure can be given to the back surface of the injection piston 15 by the working fluid inside the communicating tube 25. Therefore, a configuration whereby the capacity of the head side chamber 21h becomes zero when the injection piston 15 is positioned at the backward limit becomes possible. As a result, a reduction of size of the front cylinder member 21 can be expected.

Further, in the present embodiment, the outside diameter D₃ of the communicating tube 25 is less than the inside diameter of the front cylinder member 21, and the injection device 1 moves the front cylinder member 21 forward by the driving device 11 in a state where the forward movement of the plunger 5 is limited by the solidified molten metal, whereby the working fluid which exists in the front cylinder member 21 at the back of the injection piston 15 is supplied to the small diameter chamber 23a and the boosting piston 17 is made to retract.

Accordingly, the injection piston 15 and boosting piston 17 can be retracted by the driving device 11. As a result, for example, the accumulator 37 can be filled by the pump 33 when retracting the injection piston 15 and boosting piston 17 and the molding cycle can be shortened. Further, for example, the biscuit can be ejected by the driving device 11 after this operation, so the operation is efficient.

### Second Embodiment

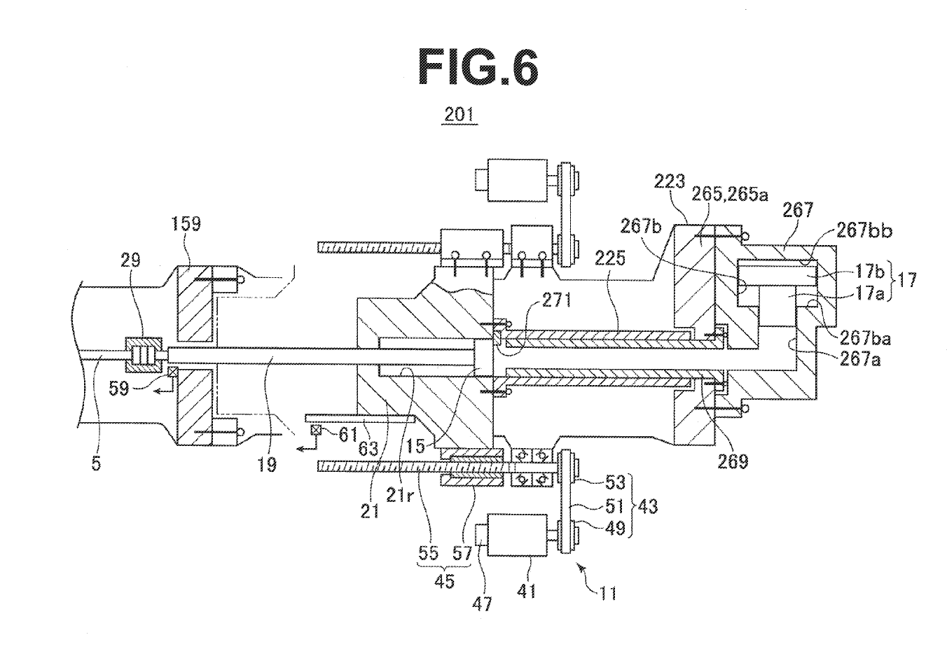

FIG. 6 is a cross-sectional view seen from the upper part schematically showing the configuration of principal parts of an injection device 201 according to a second embodiment. Note that, in the second embodiment, configurations which are the same as or similar to the configurations in the first embodiment are assigned the same notations as the notations in the first embodiment and explanations will be sometimes omitted.

The injection device 201 differs from the injection device 1 in the first embodiment in the shapes of the communicating tube and back cylinder member. Specifically, this is as follows.

A back cylinder member 223 has a base part 265 which is fixed to the base 113, a boosting portion 267 which is fixed to the base part 265 and accommodates the boosting piston 17, and a coupling part 269 which is fixed to the base part 265 and communicates with the front end of the boosting portion 267.

The base part 265 for example has a plate portion 265a facing the front-back direction. In the plate portion 265a, an opening penetrating through the front-back direction is formed.

The boosting portion 267 has a small diameter chamber 267a in which the small diameter portion 17a of the boosting piston 17 slides and a large diameter chamber 267b in which the large diameter portion 17b of the boosting piston 17 slides. The large diameter chamber 267b is partitioned into a front side chamber 267ba and a rear side chamber 267bb by the large diameter portion 17b.

The small diameter chamber 267a is bent at a suitable angle (for example 90°). The front side portion of the small diameter chamber 267a extends in the front-back direction and communicates with the coupling part 269. The back side portion of the small diameter chamber 267a and the large diameter chamber 267b extend in the direction perpendicular to the front-back direction. In other words, the boosting piston 17 is made slidable in a direction perpendicular to the front-back direction.

The coupling part 269 is for example a roughly tubular member which does not have flexibility. The coupling part 269 is arranged so as to extend in the front-back direction. Its rear end is fixed to the base part 265. The opening of the rear end communicates with the front end of the small diameter chamber 267a. The inside diameter of the coupling part 269 is for example made a bit smaller than the inside diameter of the front cylinder member 21 and is the same as the diameter of the small diameter chamber 267a.

The communicating tube 225 is for example a roughly tubular member which does not have flexibility. The communicating tube 225 is arranged so as to extend in the front-back direction. Its front end is fixed to the rear end of the front cylinder member 21. The opening on the front of the communicating tube 225 communicates with the opening of the rear end of the front cylinder member 21.

The inside diameter of the communicating tube 225 is made the outside diameter or more (in the present embodiment, equal to it) of the coupling part 269. The coupling part 269 is inserted into the communicating tube 225. Due to this, the internal portion of the coupling part 269 communicates with the internal portion of the front cylinder member 21. The coupling part 269 and the communicating tube 225 can relatively move (slide) in the front-back direction.

Further, the inside diameter of the communicating tube 225 is for example made the inside diameter or more (in the present embodiment, equal to it) of the front cylinder member 21. Accordingly, the front end of the communicating tube 225 does not abut against the rear end face of the injection piston 15 unlike the communicating tube 25 in the first embodiment.

In place of this, the front cylinder member 21 is provided with a stopper 271 which abuts against the rear end face of the injection piston 15 and defines the backward limit of the injection piston 15 with respect to the front cylinder member 21. The stopper 271 is for example fixed to the rear end of the front cylinder member 21 and projects toward the internal portion side of the front cylinder member 21 by a predetermined projection amount. The stopper 271 is for example partially provided in (with respect to) the circumferential direction of the front cylinder member 21. In other words, the stopper 271 is not provided over the entire circumference with respect to the inner circumferential surface of the front cylinder member 21. The position and number of the stoppers 271 may be suitably set.

Note that, in FIG. 6, although illustration is omitted, in the same way as the injection device 1 in the first embodiment, the injection device 201 has a hydraulic apparatus 9. The working fluid may be supplied to the head side chamber 21h by for example supplying the working fluid to the small diameter chamber 267a in the same way as the first embodiment.

The operation of the injection device 201 is roughly the same as the operation of the injection device 1 in the first embodiment. Note, in the injection device 201, the back cylinder member 223 is inserted into the communicating tube 225, therefore the amount of enlargement of the capacity of the back of the cylinder part 213 (communicating tube 225 and back cylinder member 223) at the time when the communicating tube 225 moves forward is equal to a portion of the capacity and volume of the back cylinder member 223, the portion moving from the internal portion to the external portion of the communicating tube 225. In other words, while in the first embodiment, the amount of enlargement of the capacity is defined by the outside diameter of the communicating tube 25, in the present embodiment, it is defined by the inside diameter of the communicating tube 225.

Accordingly, for example, in the high speed injection, whether the speed V₂ in the case where the forward movement of the front cylinder member 21 continues becomes faster than the speed V₁ in the case where the front cylinder member 21 is stopped is determined by the relative magnitude between the cross-sectional area of the internal portion of the communicating tube 225 as the cross-sectional area of the capacity which is enlarged, and the pressure receiving area of the back of the injection piston 15.

Note that, in the present embodiment, the inside diameter of the front cylinder member 21 and the inside diameter of the communicating tube 225 are the same. Therefore, if ignoring the influence of the amount of discharge of the working fluid of the rod side chamber 21r etc., the speed of the plunger 5 when moving the front cylinder member 21 forward is equal to the speed of the plunger 5 when stopping the front cylinder member 21.

Further, for example, when moving the front cylinder member 21 forward in a state where the forward movement of the plunger 5 is limited by the biscuit, whether a flow of the working fluid causing the boosting piston 17 to be retracted occurs is determined by the relative magnitude between the cross-sectional area of the internal portion of the communicating tube 225 and the pressure receiving area of the back of the injection piston 15.

Note that, in the present embodiment, the inside diameter of the front cylinder member 21 and the inside diameter of the communicating tube 225 are the same, therefore no flow of the working fluid causing the boosting piston 17 to retract is generated. The boosting piston 17 may be retracted by supply of the working fluid to the small diameter chamber 267a by the pump 33.

As described above, in the second embodiment, the injection device 1 has the injection cylinder device 207 which is connected to the plunger 5 and has the driving device 11 which can drive the plunger 5 to move forward through the injection cylinder device 207. The cylinder part 213 of the injection cylinder device 207 has the front cylinder member 21 which accommodates the injection piston 15 so that it can slide in the front-back direction, is opened in the rear end, and is movable in the front-back direction. Further, the cylinder part 213 has the back cylinder member 223 which is communicated with the rear end of the front cylinder member 21 and is provided in a fixed manner. The driving device 11 can drive the front cylinder member 21 in the front-back direction.

Accordingly, the same effects as those by the first embodiment are exerted. For example, in the reaction force (injection force) which is generated when supplying the working fluid to the back of the injection piston 15, an amount corresponding to the opening area of the rear end of the front cylinder member 21 (cross-sectional area of the internal portion of the communicating tube 225) will be received by the back cylinder member 223 which is provided in a fixed manner. As a result, for example, the load of the driving device 11 is lightened. Further, for example, acceleration at a time of high speed is suitably carried out.

Note that, in the present embodiment, the boosting piston 17 is arranged so that it can move in a direction perpendicular to the front-back direction. Accordingly, in more detail, in contrast to the first embodiment in which the reaction force was received by the rear end face of the large diameter chamber 23b through the boosting piston 17, in the present embodiment, the reaction force is received by a surface in the inner circumferential surface of the small diameter chamber 267a which faces the front.

Further, in the present embodiment, the injection cylinder device 207 further has the communicating tube 225 which is fixed to the rear end of the front cylinder member 21, into which the back cylinder member 223 is inserted so that it can relatively move, and which makes the front cylinder member 21 and the back cylinder member 223 communicate with each other.

Accordingly, the same effect as the effect due to the provision of the communicating tube 25 in the first embodiment is exerted. For example, it is easy to enlarge the opening area of the rear end of the front cylinder member 21. Further, it is easy to secure the amount of flow of the working fluid which flows between the front cylinder member 21 and the back cylinder member 223. Further, the present embodiment is configured so that the back cylinder member 223 is inserted into the communicating tube 225, therefore it is easy to enlarge the inside diameter of the communicating tube 225. As a result, the action of the reaction force (injection force) upon the front cylinder member 21 due to the fluid pressure which acts upon the front end face of the communicating tube 225 is easily suppressed. Note, in the present embodiment, the effect of making the working fluid act upon the rear end of the communicating tube 225 is not obtained.

Further, in the present embodiment, the inside diameter of the communicating tube 225 is the inside diameter of the front cylinder member 21 or more. On the rear end of the front cylinder member 21, the cylinder part 213 has a stopper 271 provided partially with respect to the circumferential direction of the front cylinder member 21 which projects toward the inside of the front cylinder member 21 and defines the backward limit of the injection piston 15 by abutting against the rear end of the injection piston 15.

Accordingly, in comparison with the case where the stopper of the injection piston 15 is configured by the communicating tube 25 having a smaller inside diameter than the inside diameter of the front cylinder member 21 as in the first embodiment, it is easy to make the pressure receiving area facing forward small. In other words, it is easy to enlarge the opening area of the rear end of the front cylinder member 21. As a result, it becomes easier to receive the reaction force (injection force) by the back cylinder member 223.

The present invention is not limited to the above embodiments and may be executed in variable ways.

The molding machine is not limited to a die cast machine. For example, the molding machine may be another metal molding machine, may be an injection molding machine molding a resin, or may be a molding machine molding a material comprised of sawdust mixed with a thermoplastic resin or the like. Further, the molding machine is not limited to horizontal mold clamping and horizontal injection. For example, it may be vertical mold clamping and vertical injection, vertical mold clamping and horizontal injection, or horizontal mold clamping and vertical injection. The working fluid is not limited to oil and may be for example water as well.

The first embodiment and the second embodiment may be suitably combined. That is, as the difference between the first embodiment and the second embodiment, there can be mentioned an insertion relationship between the communicating tube and the back cylinder member, orientation of the boosting piston, relative magnitude between the inside diameter of the front cylinder member and the inside diameter (or outside diameter) of the communicating tube, configuration of the stopper, and so on, however, concerning them, either of the two embodiments may be selected.

For example, in the first embodiment, just the orientation of the boosting piston may be changed so that it becomes a direction perpendicular to the front-back direction as in the second embodiment. Further, for example, the inside diameter of the communicating tube inserted into the back cylinder member as in the first embodiment may be made to become equal to or more than the inside diameter of the front cylinder member as in the second embodiment, and the stopper of the second embodiment may be provided as well. Conversely, the inside diameter of the communicating tube into which the back cylinder member is inserted as in the second embodiment may be made smaller than the inside diameter of the front cylinder member as in the first embodiment as well.

The injection cylinder device is not limited to the boosting type and may be a so-called single acting type as well in which a boosting piston is not provided. In other words, the back cylinder member need not accommodate a boosting piston and may be provided for only the purpose of receiving the reaction force (injection force).

The driving device is not limited to one including a rotating type electric motor and, for example, may be one including a linear motor as well. Further, in the case where a rotating type electric motor is included, the mechanism of transforming the rotation to the translational motion is not limited to a screw mechanism and may be for example a rack and pinion mechanism as well. Further, the pulley belt mechanism need not be provided. In addition to or in place of the pulley belt mechanism, a gear mechanism or another suitable transmission mechanism may be provided as well.

The division of roles of the injection cylinder device and the driving device may be suitably set. For example, the ejection tracking need not be carried out by the driving force of the driving device, but may be carried out by the driving force of the injection cylinder device. Further, for example, for boosting and pressure retention, in addition to the driving force of the injection cylinder device, the driving force of the driving device may be utilized as well.

The stroke of the front cylinder member (stroke of the driving device) need not be equal to the stroke of the plunger and may be equal to the stroke of the low speed injection. In this case, reduction of size of the driving device is achieved. For example, the screw shaft in the embodiment can be made shorter. Note that, in this case, the retraction of the injection piston relative to the front cylinder member may be carried out by the supply of the working fluid to the rod side chamber. Further, the ejection tracking may be carried out by the driving force of the injection cylinder device.

The communicating tube need not be provided. For example, the front cylinder member and the back cylinder member may be communicated with each other by a flexible hose as well. In this case, in comparison with the case where the communicating tube is provided, the change of the capacity behind the injection piston is suppressed. Note, the communicating tube can easily secure the flow rate.

Further, the communicating tube may be fixed not to the front cylinder member, but to the back cylinder member. For example, the front cylinder member may be connected to the driving device 11 on the front end, and the back portion of the front cylinder member may be inserted into the communicating tube which is provided at the front of the back cylinder member as well. Note, in this case, the communicating tube may be grasped as a portion of the back cylinder member as well (it may be grasped that a communicating tube is not provided and the front cylinder member is directly inserted into the back cylinder member).

Priority is claimed on Japanese application No. 2014-116570, filed on Jun. 5, 2014, the content of which is incorporated herein by reference.

### REFERENCE SIGNS LIST

1 . . . injection device, 3 . . . sleeve, 5 . . . plunger, 7 . . . injection cylinder device, 11 . . . driving device, 13 . . . cylinder part, 15 . . . injection piston, 19 . . . piston rod, 21 . . . front cylinder member, 23 . . . back cylinder member, and 105 . . . cavity.

1. An injection device comprising:
a sleeve which is communicated with a cavity;
a plunger which is capable of sliding in a front-back direction in the sleeve;
an injection cylinder device which includes
a piston rod which is connected to the plunger,
an injection piston which is fixed to the piston rod, and
a cylinder part which accommodates the injection piston; and
a driving device which is capable of driving the plunger to move forward through the injection cylinder device, wherein
the cylinder part has
a front cylinder member which accommodates the injection piston so that it can slide in a front-back direction, is opened at the rear end, and is movable in a front-back direction and
a back cylinder member which communicates with the rear end of the front cylinder member and is provided in a fixed manner, and
the driving device can drive the front cylinder member in the front-back direction.

2. The injection device as set forth in claim 1, wherein
the back cylinder member has
a small diameter chamber which communicates with the rear end of the front cylinder member and
a large diameter chamber which communicates with the small diameter chamber and has a larger diameter than the small diameter chamber, and
the injection cylinder device further has a boosting piston having a small diameter portion which can slide in the small diameter chamber and a large diameter portion which can slide in the large diameter chamber formed therein.

3. The injection device as set forth in claim 1, wherein the injection cylinder device further has a communicating tube which is fixed to the rear end of the front cylinder member, is inserted into the back cylinder member so that it can relatively move, and makes the front cylinder member and the back cylinder member communicate with each other.

4. The injection device as set forth in claim 2, wherein the injection cylinder device further has a communicating tube which is fixed to the rear end of the front cylinder member, is inserted into the back cylinder member so that it can relatively move, and makes the front cylinder member and the back cylinder member communicate with each other.

5. The injection device as set forth in claim 1, wherein the injection cylinder device further has a communicating tube which is fixed to the rear end of the front cylinder member, into which the back cylinder member is inserted so that it can relatively move, and which makes the front cylinder member and the back cylinder member communicate with each other.

6. The injection device as set forth in claim 2, wherein the injection cylinder device further has a communicating tube which is fixed to the rear end of the front cylinder member, into which the back cylinder member is inserted so that it can relatively move, and which makes the front cylinder member and the back cylinder member communicate with each other.

7. The injection device as set forth in claim 3, wherein
the inside diameter of the communicating tube is less than the inside diameter of the front cylinder member, and
the front end of the communicating tube defines the backward limit of the injection piston with respect to the front cylinder member by abutting against the rear end of the injection piston.

8. The injection device as set forth in claim 4, wherein
the inside diameter of the communicating tube is less than the inside diameter of the front cylinder member, and
the front end of the communicating tube defines the backward limit of the injection piston with respect to the front cylinder member by abutting against the rear end of the injection piston.

9. The injection device as set forth in claim 5, wherein
the inside diameter of the communicating tube is less than the inside diameter of the front cylinder member, and
the front end of the communicating tube defines the backward limit of the injection piston with respect to the front cylinder member by abutting against the rear end of the injection piston.

10. The injection device as set forth in claim 6, wherein
the inside diameter of the communicating tube is less than the inside diameter of the front cylinder member, and
the front end of the communicating tube defines the backward limit of the injection piston with respect to the front cylinder member by abutting against the rear end of the injection piston.

11. The injection device as set forth in claim 3, wherein
the inside diameter of the communicating tube is the inside diameter of the front cylinder member or more, and
the cylinder part has, at the rear end of the front cylinder member, a stopper provided partially with respect to the circumferential direction of the front cylinder member which projects out toward the inside of the front cylinder member and defines the backward limit of the injection piston with respect to the front cylinder member by abutting against the rear end of the injection piston.

12. The injection device as set forth in claim 4, wherein
the inside diameter of the communicating tube is the inside diameter of the front cylinder member or more, and
the cylinder part has, at the rear end of the front cylinder member, a stopper provided partially with respect to the circumferential direction of the front cylinder member which projects out toward the inside of the front cylinder member and defines the backward limit of the injection piston with respect to the front cylinder member by abutting against the rear end of the injection piston.

13. The injection device as set forth in claim 5, wherein
the inside diameter of the communicating tube is the inside diameter of the front cylinder member or more, and
the cylinder part has, at the rear end of the front cylinder member, a stopper provided partially with respect to the circumferential direction of the front cylinder member which projects out toward the inside of the front cylinder member and defines the backward limit of the injection piston with respect to the front cylinder member by abutting against the rear end of the injection piston.

14. The injection device as set forth in claim 6, wherein
the inside diameter of the communicating tube is the inside diameter of the front cylinder member or more, and
the cylinder part has, at the rear end of the front cylinder member, a stopper provided partially with respect to the circumferential direction of the front cylinder member which projects out toward the inside of the front cylinder member and defines the backward limit of the injection piston with respect to the front cylinder member by abutting against the rear end of the injection piston.

15. The injection device as set forth claim 1, wherein the driving device has
a screw mechanism which has a screw shaft extending in the front-back direction and a nut which is screwed with the screw shaft, one of the screw shaft and the nut being fixed to the front cylinder member; and
an electric motor which makes the other of the screw shaft and the nut rotate.

16. A molding apparatus comprising the injection device as set forth in claim 1.
